(19) United States
(12) Patent Application Publication
(10) Pub. No.: US 2025/0310648 A1
(43) Pub. Date: Oct. 2, 2025

(54) APPARATUS AND METHOD FOR SURROUND-VIEW MONITORING FOR A VEHICLE

(71) Applicants: HYUNDAI MOTOR COMPANY, Seoul (KR); KIA CORPORATION, Seoul (KR)

(72) Inventors: Dong Yeop Kim, Dalseo-gu (KR); Do Hyun Park, Hwaseong-si (KR); Jae Seop Choi, Suwon-si (KR); Jeong Muk Jo, Hwaseong-si (KR)

(73) Assignees: HYUNDAI MOTOR COMPANY, Seoul (KR); KIA CORPORATION, Seoul (KR)

(21) Appl. No.: 18/970,424

(22) Filed: Dec. 5, 2024

(30) Foreign Application Priority Data
Mar. 29, 2024 (KR) 10-2024-0043085

(51) Int. Cl. H04N 23/698

(52) U.S. Cl. CPC H04N 23/698

(57) ABSTRACT

An apparatus for surround-view monitoring for a vehicle includes a plurality of cameras, a display, and a controller. The controller is configured to generate a surround-view image containing a blind area by synthesizing a plurality of images obtained from the plurality of cameras. The controller is also configured to correct the blind area by utilizing image data of the surroundings of the blind area in the generated surround-view image. The controller is further configured to output the corrected surround-view image to the display.

### CROSS-REFERENCE TO RELATED APPLICATIONS

This application claims the benefit of and priority to, Korean Patent Application Number 10-2024-0043085, filed Mar. 29, 2024, the entire contents of which are hereby incorporated herein by reference.

### TECHNICAL FIELD

The present disclosure relates to an apparatus and method for surround-view monitoring for a vehicle, more particularly, to a technology that displays a blind spot in a surround-view image for a vehicle.

### BACKGROUND

The statements in this section merely provide background information related to the present disclosure and may not necessarily constitute prior art.

For the convenience of users of vehicles, advanced driver-assistance systems (ADAS) are developed and applied in the vehicles. Also, the development of autonomous vehicles is actively under way.

A surround-view monitoring (SVM) system offers the driver a view of the surroundings when driving or parking to enhance safety and convenience of vehicle driving. The surround-view monitoring system synthesizes images captured by a plurality of cameras mounted at the front, back, and left and right sides of the vehicle to show multiple views of the surroundings. In some cases, there is a blind spot that the camera cannot capture because the camera's field of view is obscured depending on the installation position, posture, or body of the camera. An area corresponding to a blind spot in an SVM image (hereinafter, “blind area”) has no image information to be rendered.

### SUMMARY

The present disclosure provides an apparatus and method for rendering a blind area of an SVM image by utilizing images of the surroundings of the blind spot.

The aspects of the present disclosure are not limited to the foregoing. Other aspects not mentioned herein should be more clearly understood by those having ordinary skill in the art from the following description.

According to an embodiment of the present disclosure, an apparatus for surround-view monitoring for a vehicle is provided. The apparatus includes a plurality of cameras and a display. The apparatus also includes a controller configured to generate a surround-view image having a blind area by synthesizing a plurality of images obtained from the plurality of cameras, generate a corrected surround-view image by correcting the blind area using image data of the surroundings of the blind area in the surround-view image, and output the corrected surround-view image to the display.

The controller may be configured to set a certain region of interest around the blind area in the generated surround-view image, obtain a virtual image by cropping the set region of interest and resizing the same, and replace a target sub-area in the blind area that corresponds to the region of interest with the obtained virtual image.

The controller may further be configured to perform filtering on the target sub-area for which the virtual image is substituted.

The controller may be configured to synthesize the surround-view image and a vehicle image such that the vehicle image is disposed in the blind area.

The controller may be configured to adjust the brightness of the blind area based on the brightness of the set region of interest when the vehicle is in parking mode.

According to another embodiment of the present disclosure, a method for surround-view monitoring for a vehicle is provided. The method includes generating a surround-view image having a blind area by synthesizing a plurality of images obtained from the plurality of cameras, generating a corrected surround-view image by correcting the blind area by utilizing image data of surroundings of the blind area in the surround-view image, and outputting the corrected surround-view image to the display.

Generally, SVM images may be generated by masking the blind area in black or applying a gradation effect to the blind area. In some cases, however, masking the blind area in black or applying a gradation effect may make the SVM image look unnatural. According to embodiments of the present disclosure, it is possible to improve the quality of the SVM image by using images around a blind spot to make the blind area in an SVM image look natural.

The effects of the present disclosure are not limited to the foregoing. Other effects not mentioned herein should be more clearly understood by those having ordinary skill in the art from the following description.

### BRIEF DESCRIPTION OF THE DRAWINGS

FIG. 1 is an illustrative block diagram of a part of an autonomous vehicle to which embodiments of the present disclosure are applied.

FIG. 2 is a block diagram of a surround-view monitoring apparatus according to an embodiment of the present disclosure.

FIG. 3 is a diagram illustrating a surround-view image and a blind area generated by a surround-view monitoring apparatus according to an embodiment of the present disclosure.

FIG. 4 is a diagram illustrating a process in which a surround-view monitoring apparatus corrects a blind area within a surround-view image according to an embodiment of the present disclosure.

FIG. 5 is a flowchart of a method performed by a surround-view monitoring apparatus according to an embodiment of the present disclosure.

### DETAILED DESCRIPTION

Hereinafter, embodiments of the present disclosure are described in detail with reference to the accompanying illustrative drawings. In the following description and the accompanying drawings, like reference numerals designate like elements even when the elements are shown in different drawings. Further, in the following description, where it was determined that a detailed description of related known components and functions may obscure the gist of the present disclosure, the detailed description thereof has been omitted for the purpose of clarity and for brevity.

Various ordinal numbers or alpha codes such as first, second, i), ii), a), b), etc., are prefixed solely to differentiate one component from another. Such terms not to imply or suggest the substances, order, or sequence of the components. Throughout this specification, expressions such as “include,” “comprise,” “have,” and the like are intended to indicate the presence of features, numbers, steps, operations, components, parts, or combinations thereof described herein, and should not be understood as precluding the possibility of the presence or the addition of one or more other features, numbers, steps, operations, components, parts, or combinations thereof.

The terms such as “unit,” “module,” and the like refer to one or more units for processing at least one function or operation, which may be implemented by hardware, software, or a combination thereof.

When a component, device, element, or the like of the present disclosure is described as having a purpose or performing an operation, function, or the like, the component, device, or element should be considered herein as being “configured to” meet that purpose or perform that operation or function.

The description presented below in conjunction with the accompanying drawings is intended to describe illustrative embodiments of the present disclosure and is not intended to represent the only embodiments in which the technical idea of the present disclosure may be practiced.

The present disclosure relates to an apparatus and method for surround-view monitoring for a vehicle, capable of rendering a blind spot in an SVM image to look natural by utilizing images of the surroundings of the blind spot, thereby improving the quality of the SVM image.

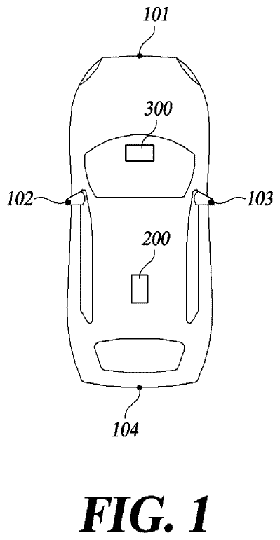

FIG. 1 is an illustrative block diagram of a part of an autonomous vehicle to which embodiments of the present disclosure are applied.

Referring to FIG. 1, a vehicle according to an embodiment of the present disclosure includes a plurality of cameras 101, 102, 103, and 104, a controller 200, and a display 300. Although FIG. 1 illustrates that the plurality of cameras includes a first camera 101, a second camera 102, a third camera 103, and a fourth camera 104, fewer or more than four cameras may be provided on the vehicle.

The plurality of cameras 101, 102, 103, and 104 captures images of the surroundings of the vehicle. Captured images are input sources for generating a surround-view image that are provided to the controller 200. Although the plurality of cameras is illustrated as being mounted at the front and rear of the vehicle and at the bottom of left/right outside mirrors, the present disclosure is not limited thereto. The plurality of cameras may be super-wide angle cameras with a view angle of 180 degrees or greater.

The first camera 101 may capture an image of the front of the vehicle. The first camera 101 may be provided inside a bumper or grille of the vehicle. However, the present disclosure is not limited thereto.

The second camera 102 may capture an image of the left side of the vehicle. The second camera 102 may be provided on a left outside mirror of the vehicle. However, the present disclosure is not limited thereto. The left outside mirror may include a mirror, various electrical components, a case that surrounds the mirror and the electrical components, and so on. The left outside mirror may be called a left outside mirror module. The second camera 102 may be provided on a left front door of the vehicle. The left front door may be a concept that includes the left outside mirror.

The third camera 103 may capture an image of the right side of the vehicle. The third camera 103 may be provided on a right outside mirror of the vehicle. However, the present disclosure is not limited thereto. The right outside mirror may include a mirror, various electrical components, a case that surrounds the mirror and the electrical components, and so on. The right outside mirror may be called a right outside mirror module. The third camera 103 may be provided on a right front door of the vehicle. The right front door may be a concept that includes the right outside mirror.

The fourth camera 104 may capture an image of the rear of the vehicle. The fourth camera 104 may be provided on a back door. However, the present disclosure is not limited thereto. The back door may include a trunk and a tailgate.

The controller 200 controls an overall operation of the surround-view monitoring apparatus. The controller 200 may generate a surround-view image by synthesizing a plurality of images obtained from the plurality of cameras 101, 102, 103, and 104. The controller 200 may correct a blind area included in the generated surround-view image.

The controller 200 may output the surround-view image with the corrected blind area to the display 300.

The display 300 may display an image output from the controller 200. The display 300 may display a surround-view image and/or an image taken of the surroundings of a point of view selected by the driver. The display 300 may include a digital cluster of the vehicle, an AVN display, an infotainment display, and/or a head-up display (HUD). However, the present disclosure is not limited thereto.

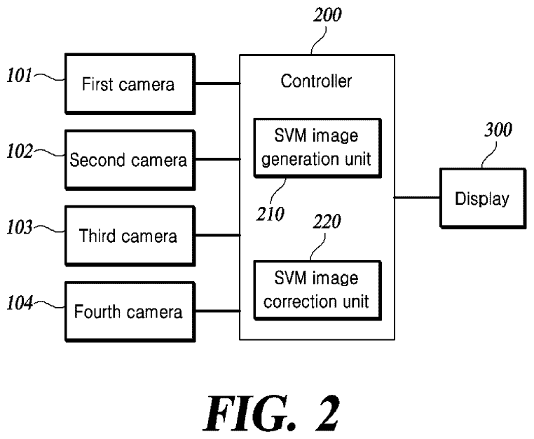

FIG. 2 is a block diagram of a surround-view monitoring apparatus according to an embodiment of the present disclosure.

Referring to FIG. 2, the surround-view monitoring apparatus according to an embodiment of the present disclosure includes a plurality of cameras 101, 102, 103, and 104, a controller 200, and a display 300.

The components of the surround-view monitoring apparatus may send or receive signals or data by using various communication protocols that are present in the vehicle. The communication protocols may include at least one of CAN (Controller Area Network), CAN FD (Controller Area Network Flexible Data-rate), LIN (Local Interconnect Network), FlexRay, and/or Ethernet.

A description of the plurality of cameras 101, 102, 103, and 104, according to embodiments, is as provided above.

The controller 200 may be disposed within the vehicle. The controller 200 may may be Electronic Control Unit (ECU), for example. The controller 200 may include a hardware processor and a memory. The memory may store commands for execution by the controller 20. However, the present disclosure is not limited thereto. The memory may include all components for the overall operation of the surround-view monitoring apparatus.

The controller 200 may generate a surround-view image having or containing a blind area by synthesizing a plurality of images obtained from the plurality of cameras 101, 102, 103, and 104. The controller 200 may correct the blind area by utilizing image data of the surroundings of the blind area in the generated surround-view image. The controller 200 may output the surround-view image to the display 300, with the blind area corrected to look natural. To this end, the controller 200 may include an SVM image generation unit 210 and an SVM image correction unit 220.

The SVM image generation unit 210 may generate a surround-view image having or containing a blind area by synthesizing a plurality of images obtained from the plurality of cameras 101, 102, 103, and 104. As used herein, the blind area refers to an area where there is no image data to be rendered in the surround-view image, which corresponds to a blind spot. As used herein, the blind spot refers to an area that the plurality of cameras 101, 102, 103, and 104 cannot capture because the camera's field of view is obscured depending on the installation position, posture, or body of the camera. For example, the blind spot may be a specific area on the road where the vehicle is located.

The SVM image generation unit 210 may generate a surround-view image by masking the blind area in black and/or applying a gradation effect to the blind area.

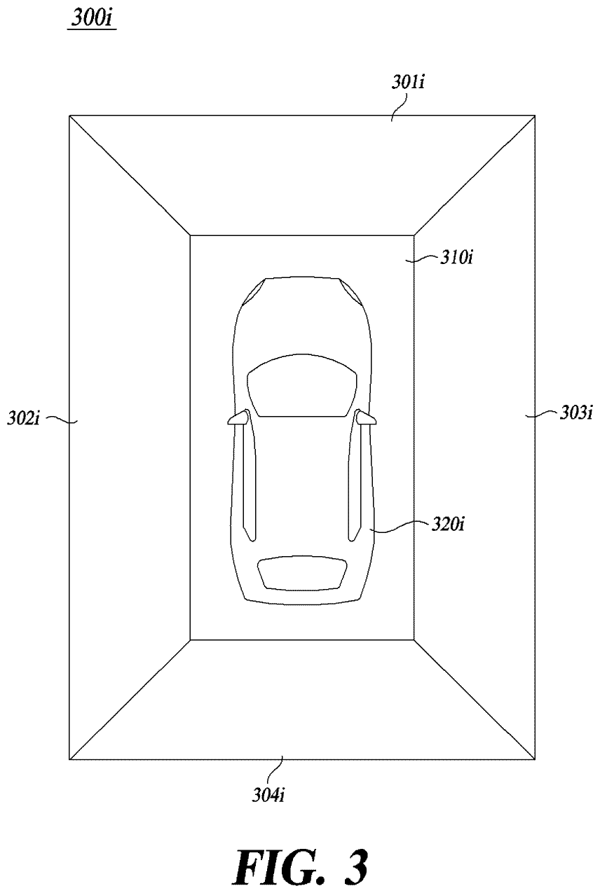

The surround-view image generated by the SVM image generation unit 210 and the blind area, according to an embodiment, are described in more detail below with reference to FIG. 3.

Referring to FIG. 3, the SVM image generation unit 210 may generate a surround-view image 300i containing a blind area by synthesizing a first image obtained from the first camera 101, a second image obtained from the second camera 102, a third image obtained from the third camera 103, and a fourth image obtained from the fourth camera 104. The first image may be an image of the front of the vehicle. The second image may be an image of the left side of the vehicle. The third image may be an image of the right side of the vehicle. The fourth image may be an image of the rear of the vehicle.

The surround-view image 300i may include an image of multiple views such as a top view, a side view, a front view, a rear view, etc. The surround-view image 300i may be a 2D image or a 3D image.

The surround-view image 300i includes areas that respectively correspond to the plurality of images obtained from the plurality of cameras 101, 102, 103, and 104. For example, the surround-view image 300i may include a first area 301i, a second area 302i, a third area 303i, and a fourth area 304i. The first area 301i may be an area that corresponds to the first image. The second area 302i may be an area that corresponds to the second image. The third area 303i may be an area that corresponds to the third image. The fourth area 304i may be an area that corresponds to the fourth image.

The surround-view image 300i includes a blind area 310i that corresponds to the blind spot where there is no image data to be rendered in the surround-view image. The blind area 310i may be masked in black and/or a gradation effect may be applied to the blind area 310i.

The surround-view image 300i may include a vehicle image 320i that corresponds to the vehicle. The SVM image correction unit 220, described in more detail below, may render the vehicle image 320i to be included in the surround-view image 300i.

Referring again to FIG. 2, the SVM image correction unit 220 may correct the blind area 310i by utilizing image data of the surroundings of the blind area included in the generated surround-view image.

The SVM image correction unit 220 may set at least one region of interest around the blind area in the generated surround-view image. The SVM image correction unit 220 may obtain a virtual image by cropping the set region of interest and resizing it to fit the size of a target sub-area within the blind area. The SVM image correction unit 220 replaces the target sub-area within the blind area with the virtual image.

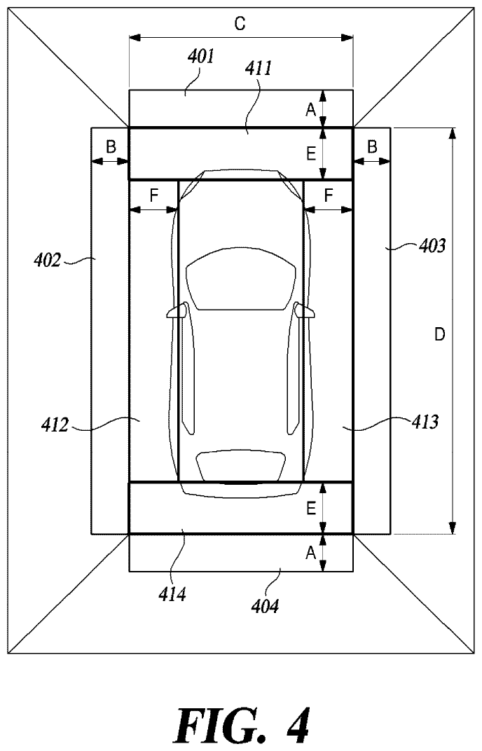

Referring to FIG. 4 as well, a process of correcting a blind area of a surround-view image by the SVM image correction unit 220, according to an embodiment, is described.

In an example, the SVM image correction unit 220 may set a first region of interest 401 in front of the blind area 310i, may obtain a first virtual image by cropping the first region of interest 401 and resizing it, and may substitute the first virtual image for a first target sub-area 411 within the blind area 310i. The first region of interest 401 may be set to be adjacent to the blind area 310i. The size of the first region of interest 401 may be set in such a way as to have the same horizontal length (C) as the blind area 310i and a predetermined vertical length (A) (e.g., 20 pixels). The size of the first target sub-area 411 may be set in such a way as to have the same horizontal length (C) as the blind area 310i and a predetermined vertical length (E) (e.g., ⅛ the vertical length of the blind area 310i). The first virtual image is the same size as the first target sub-area 411.

In an example, the SVM image correction unit 220 may set a second region of interest 402 to the left side of the blind area 310i, may obtain a second virtual image by cropping the second region of interest 402 and resizing it, and may substitute the second virtual image for a second target sub-area 412 within the blind area 310i. The second region of interest 402 may be set to be adjacent to the blind area 310i. The size of the second region of interest 402 may be set in such a way as to have a predetermined horizontal length (B) (e.g., 20 pixels) and the same vertical length (D) as the blind area 310i. The size of the second target sub-area 412 may be set in such a way as to have a predetermined horizontal length (F) (e.g., ¼ the horizontal length of the blind area 310i) and a vertical length obtained by subtracting the vertical length of the first target sub-area 411 and the vertical length of a fourth target sub-area 414 from the vertical length of the blind area 310i. The second virtual image is the same size as the second target sub-area 412.

In an example, the SVM image correction unit 220 may set a third region of interest 403 to the right side of the blind area 310i, may obtain a third virtual image by cropping the third region of interest 403 and resizing it, and may substitute the third virtual image for a third target sub-area 413 within the blind area 310i. The third region of interest 403 may be set to be adjacent to the blind area 310i. The size of the third region of interest 403 may be set in such a way as to have a predetermined horizontal length (B) (e.g., 20 pixels) and the same vertical length (D) as the blind area 310i. The size of the third target sub-area 413 may be set in such a way as to have a predetermined horizontal length (F) (e.g., ¼ the horizontal length of the blind area 310i) and a vertical length obtained by subtracting the vertical length of the first target sub-area 411 and the vertical length of a fourth target sub-area 414 from the vertical length of the blind area 310i. The third virtual image is the same size as the third target sub-area 413.

In an example, the SVM image correction unit 220 may set a fourth region of interest 404 in rear of the blind area 310i, may obtain a fourth virtual image by cropping the fourth region of interest 404 and resizing it, and may substitute the fourth virtual image for a fourth target sub-area 414 in the blind area 310i. The fourth region of interest 404 may be set to be adjacent to the blind area 310i. The size of the fourth region of interest 404 may be set in such a way as to have the same horizontal length (C) as the blind area 310i and a predetermined vertical length (A) (e.g., 20 pixels). The size of the fourth target sub-area 414 may be set in such a way as to have the same horizontal length (C) as the blind area 310i and a predetermined vertical length (E) (e.g., ⅛ the vertical length of the blind area 310i). The fourth virtual image is the same size as the fourth target sub-area 414.

The SVM image correction unit 220 may perform filtering such as blur on each target sub-area replaced with a corresponding virtual image. The filter, as used herein, may include a Gaussian filter. However, the present disclosure is not limited thereto.

The SVM image correction unit 220 may synthesize a corrected surround-view image and a vehicle image 320i such that the vehicle image 320i is disposed within the blind area 310i. The vehicle image 320i may be a certain 2D or 3D image depending on the specification, etc. of the vehicle. The SVM image correction unit 220 may synthesize the vehicle image 320i overlaid on a shadow image with the corrected surround-view image, in order to mitigate a sense of heterogeneity. The shadow image may be a rounded-corner rectangular image of the same size as the vehicle image 320i that is blurred on the edges. The shadow image may be applied to minimize a sense of heterogeneity between the corrected blind area 310i and the vehicle image 320i.

When the vehicle is in parking mode, the SVM image correction unit 220 may adjust the brightness of the blind area based on the brightness of the set region of interest to improve the visibility of the surround-view image. For example, if the brightness of at least two of the first region of interest 401, the second region of interest 402, the third region of interest 403, and the fourth region of interest 404 remains below a first threshold for a first duration, the SVM image correction unit 220 may increase the brightness of the blind area 310i. As anther example, if the brightness of at least two of the first region of interest 401, the second region of interest 402, the third region of interest 403, and the fourth region of interest 404 remains above a second threshold for a second duration, the SVM image correction unit 220 may decrease the brightness of the blind area 310i. The brightness of a region of interest may be an RGB average of pixels included in that region of interest, for example.

The controller 200 may output a surround-view image with the corrected blind area to the display 300.

A description of the display 300, according to an embodiment, is as provided above.

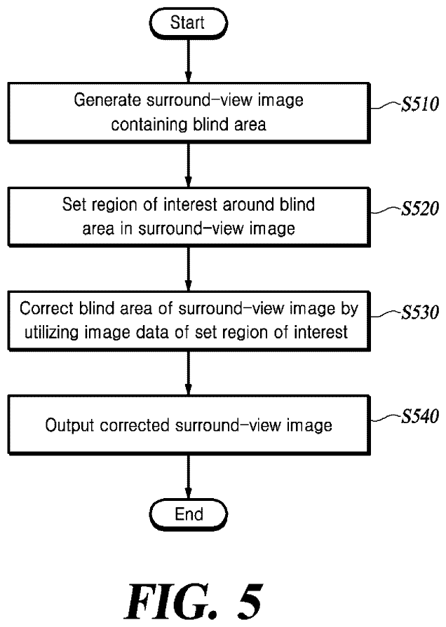

FIG. 5 is a flowchart of a method performed by a surround-view monitoring apparatus according to an embodiment of the present disclosure.

Referring to FIG. 5, in an operation S510, the surround-view monitoring apparatus generates a surround-view image having or containing a blind area by synthesizing a plurality of images obtained from a plurality of cameras 101, 102, 103, and 104. As used herein, the blind area refers to an area where there is no image data to be rendered in the surround-view image, which corresponds to a blind spot.

The surround-view monitoring apparatus may generate a surround-view image by masking the blind area in black and/or applying a gradation effect to the blind area.

In an operation S520, the surround-view monitoring apparatus sets at least one region of interest around the blind area in the generated surround-view image. This is to correct a corresponding target sub-area in the blind area by utilizing image data of the at least one region of interest.

In an operation S530, the surround-view monitoring apparatus corrects the blind area of the surround-view image using image data of set region of interest.

For example, the surround-view monitoring apparatus obtains a virtual image by cropping the set region of interest and resizing it to fit the size of the target sub-area within the blind area. The surround-view monitoring apparatus substitutes the virtual image for the target sub-area within the blind area.

The surround-view monitoring apparatus may perform filtering such as blur on each target sub-area replaced with a corresponding virtual image.

The surround-view monitoring apparatus may synthesize a corrected surround-view image and a vehicle image 320i such that the vehicle image 320i is disposed within the blind area 310i.

When the vehicle is in parking mode, the surround-view monitoring apparatus may adjust the brightness of the blind area based on the brightness of the set region of interest, in order to improve the visibility of the surround-view image according to the surrounding illumination.

In an operation S540, the surround-view monitoring apparatus may output a surround-view image with the corrected blind area to the display 300.

Each component of the device or method according to embodiments of the present disclosure may be implemented by hardware, software, or a combination of hardware and software. In addition, the function of each component may be implemented by software and the microprocessor may be implemented to execute the function of software corresponding to each component.

In various implementations, the systems and techniques described herein may be implemented by digital electronic circuits, integrated circuits, field programmable gate arrays (FPGAs), application specific integrated circuits (ASICs), computer hardware, firmware, software, and/or a combination thereof. These various implementations may include being implemented in one or more computer programs executable on a programmable system. The programmable system includes at least one programmable processor (which may be a special purpose processor or a general purpose processor) coupled to receive data and instructions from, and transmit data and instructions to, a storage system, at least one input device, and at least one output device. Computer programs (also known as programs, software, software applications or code) include instructions for a programmable processor and are stored on a “computer-readable recording medium.”

The computer-readable storage medium includes various kinds of storage devices that store data readable by a computer system. The computer-readable storage medium may include non-volatile or non-transitory medium such as ROM, CD-ROM, magnetic tape, floppy disk, memory card, hard disk, magneto-optical disk, and/or storage device, and may also further include a transitory medium such as a data transmission medium. Moreover, the computer-readable storage medium may be distributed in computer systems connected through a network, and computer-readable codes may be stored and executed in a distributed manner.

In the flowcharts in the present specification, it is described that each process sequentially occurs, but this is merely an example of the technology of an embodiment of the present disclosure. In other words, a person having ordinary skills in the art to which an embodiment of the present disclosure pertains may make various modifications and variations by changing the orders described in the flowcharts in the present specification or by undergoing one or more of the processes in parallel within the essential characteristics of an embodiment of the present disclosure. The flowcharts in this specification are not limited to a time-series order.

Although embodiments of the present disclosure have been described for illustrative purposes, those having ordinary skill in the art should appreciate that various modifications, additions, and substitutions are possible, without departing from the idea and scope of the claimed invention. Therefore, illustrative embodiments of the present disclosure have been described for the sake of brevity and clarity. The scope of the technical idea of the embodiments of the present disclosure is not limited by the illustrations. Accordingly, one of ordinary skill in the art should understand that the scope of the present disclosure is not to be limited by the above explicitly described embodiments but by the claims and equivalents thereof.

What is claimed is:

1. An apparatus for surround-view monitoring for a vehicle, the apparatus comprising:
a plurality of cameras;
a display; and
a controller configured to:
generate a surround-view image having a blind area by synthesizing a plurality of images obtained from the plurality of cameras,
generate a corrected surround-view image by correcting the blind area using image data of surroundings of the blind area in the surround-view image, and
output the corrected surround-view image to the display.

2. The apparatus of claim 1, wherein the controller is configured to generate the surround-view image by performing one or both of masking the blind area in black or applying a gradation effect to the blind area.

3. The apparatus of claim 1, wherein the controller is configured to:
set a region of interest around the blind area in the generated surround-view image;
obtain a virtual image by cropping and resizing the region of interest; and
replace a target sub-area in the blind area that corresponds to the region of interest with the obtained virtual image.

4. The apparatus of claim 3, wherein the controller is configured to resize the virtual image to fit a size of the target sub-area.

5. The apparatus of claim 3, wherein the controller is configured to perform filtering on the target sub-area for which the virtual image is substituted.

6. The apparatus of claim 3, wherein the controller is configured to synthesize the surround-view image and a vehicle image such that the vehicle image is disposed in the blind area.

7. The apparatus of claim 3, wherein the controller is configured to, when the vehicle is in parking mode, adjust a brightness of the blind area based on a brightness of the region of interest.

8. A method for surround-view monitoring for a vehicle, the method comprising:
generating a surround-view image having a blind area by synthesizing a plurality of images obtained from a plurality of cameras;
generating a corrected surround-view image by correcting the blind area using image data of surroundings of the blind area in the surround-view image; and
outputting the corrected surround-view image to a display.

9. The method of claim 8, wherein generating the surround-view image includes generating the surround-view image by performing one or both of masking the blind area in black or applying a gradation effect to the blind area.

10. The method of claim 9, wherein correcting the blind area includes:
setting a region of interest around the blind area in the generated surround-view image;
obtaining a virtual image by cropping and resizing the region of interest; and
replacing a target sub-area in the blind area that corresponds to the region of interest with the obtained virtual image.

11. The method of claim 10, wherein resizing the virtual image includes resizing the virtual image to fit a size of the target sub-area.

12. The method of claim 10, wherein correcting the blind area further includes performing filtering on the target sub-area for which the virtual image is substituted.

13. The method of claim 10, wherein correcting the blind area further includes synthesizing the surround-view image and a vehicle image such that the vehicle image is disposed in the blind area.

14. The method of claim 10, wherein the correcting the blind area further includes, when the vehicle is in parking mode, adjusting a brightness of the blind area based on a brightness of the region of interest.
